(19) United States
(12) Patent Application Publication
(10) Pub. No.: US 2002/0113865 A1
(43) Pub. Date: Aug. 22, 2002

(54) IMAGE PROCESSING METHOD AND APPARATUS

(76) Inventors: KOTARO YANO, KANAGAWA-KEN (JP); KATSUMI IIJIMA, TOKYO (JP)

Correspondence Address: FITZPATRICK CELLA HARPER & SCINTO, 30 ROCKEFELLER PLAZA, NEW YORK, NY, 10112, US

(21) Appl. No.: 09/143,432

(22) Filed: Aug. 28, 1998

(30) Foreign Application Priority Data
Sep. 2, 1997 (JP) 9-237095
Aug. 25, 1998 (JP) 10-239120

(51) Int. Cl. H04N 13/02

(52) U.S. Cl. 348/47; 382/154

(57) ABSTRACT

Three-dimensional model generating apparatus obtains a plurality of object images having overlapped field of view, which are photographed from different viewpoints, and stores image data and camera parameters of the obtained image data for each frame. Based on parallax distributions extracted from the stored image data and object regions, a model form and approximation parameters are generated to be used for performing approximation to generate a three-dimensional model of an object in the object region. A three-dimensional model of the object is generated based on the generated model form and approximation parameters, stored camera parameters and object regions.

### BACKGROUND OF THE INVENTION

The present invention relates to a three-dimensional model generating apparatus which generates a model of a three-dimensional scene based on images photographed by a camera, a medium where methods and programs for generating a three-dimensional model are stored. The present invention also relates to a three-dimensional model displaying apparatus capable of displaying a three-dimensional scene, generated by the three-dimensional model generating apparatus, as if a viewer is walking through the three-dimensional scene, and a medium where methods and programs for displaying a three-dimensional model are stored.

A conventionally known system in the related field is a system where a model scene including one or plural three-dimensional objects is generated by a system, e.g., CG (Computer Graphic) system for three-dimensional image or the like, and where a user can virtually walk through the three-dimensional space generated by the CG by operation such as shifting, rotating or the like.

However, in the conventional system, generating a CG image is extremely complicated. In addition, despite the fact that an object in reality has various texture on its surface, a CG-generated three-dimensional object generally has a uniform-colored surface. Therefore, the generated scene lacks realistic ambience when a viewer walk through the scene. To solve such problem, it is possible to paste an image photographed by a camera onto a surface of a three-dimensional object to provide texture. However, in this technique, generation of the model becomes more complicated.

Further, another conventionally known system is a system where an object is photographed by a camera from a plurality of rotational directions, the obtained plural object images are stored and an image seen from a desired rotational direction is displayed. The system of this type stores the obtained plural object images in association with each of the photographed directions. At the time of displaying, the system displays an object image photographed from a direction corresponding to an instructed rotational direction of the object image. By such function, a user can operate interactively with the object image.

FIG. 13 shows an example of a method of photographing an object image. In this example, an object 1 is fixed on a turntable 2, a camera 3 is fixed on a tripod 4, and the object is photographed. A solid-color background is generally used. Herein, the object 1 is fixed such that the center thereof is on the rotation axis 2a of the turntable 2, and an optical axis 3a of the camera 3 intersects the rotation axis 2a of the turntable 2. Furthermore, it is set so that the entire object 1 fits in the photographing frame. By rotating the turntable 2 by an equal angle each time, the object is photographed from a plurality of directions.

Then, for example, the plurality of object images photographed in the foregoing manner are arranged such that the images are outputted the same direction as the photographed direction. At the time of displaying, object images are sequentially selected and displayed in accordance with an instructed rotational direction of the object image, so as to display the image as if the object is three-dimensionally rotating.

Another conventionally-known system is a system where a three-dimensional model of an object is generated based on a plurality of object images, an image pattern of the object is pasted to the three-dimensional model, and the object image seen from an arbitrary camera position and direction is three-dimensionally displayed.

However, in such system where a plurality of object images are serially displayed in accordance with a user's instruction, an object must be photographed at an interval of small rotational angle in order to display an image as if the object is three-dimensionally rotated without giving a user an unrealistic impression. For this, a large number of object images must be photographed, requiring time-consuming photograph operation and an image memory with large capacity.

Moreover, in a case where a three-dimensional model of an object is generated and the object image is displayed by pasting image patterns, it is necessary to generate a three-dimensional model of the object with high precision. If the three-dimensional model is imprecise, distortion in the displayed object image becomes conspicuous. Generation of such a highly precise three-dimensional model requires a large amount of time for calculation.

### SUMMARY OF THE INVENTION

The present invention is made in consideration of the above situation, and has as its object to provide a method and apparatus for easily generating a three-dimensional image based on a plurality of images having parallax.

Another object of the present invention is to easily generate a three-dimensional model, where a user can virtually walk through, based on images having parallax, photographed by a camera or the like.

Another object of the present invention is to provide a method and apparatus for easily performing texture mapping on the three-dimensional model.

Another object of the present invention is to enable three-dimensional displaying of an object image based on a relatively small amount of object images, and to easily generate a three-dimensional image of an object, which does not have much image distortion, without requiring precise generation of a three-dimensional model of the object.

In order to attain the above objects, according to an aspect of the present invention, an image processing apparatus having the following configuration is provided. More specifically, the present invention provides an image processing apparatus comprising: obtaining means for obtaining first and second image data representing a first image and a second image, seen from different viewpoints and having a partially overlapped field of view; first generating means for extracting an object region including a predetermined object image from the first and second images and generating parallax data of the object region; second generating means for generating an approximation parameter to express the object region in a predetermined approximation model form in a three-dimensional space based on the parallax data; and forming means for forming a three-dimensional model of the object image based on a camera parameter related to the first and second images and the approximation parameter.

Furthermore, according to another aspect of the present invention, the present invention provides an image processing apparatus comprising: first generating means for generating a three-dimensional model of an object for each pair of adjacent object images of a plurality of object images obtained from different viewpoints; selecting means for selecting a three-dimensional model to be used based on an observation position and the viewpoints of the plurality of object images; and second generating means for generating a three-dimensional image corresponding to a viewpoint of the observation position by utilizing the three-dimensional model selected by the selecting means.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention, and together with the description, serve to explain the principles of the invention.

FIG. 1 is a block diagram showing a construction of a three-dimensional model generating apparatus and display apparatus of a three-dimensional model according to a first embodiment of the present invention;

FIG. 2 is a block diagram showing a construction of a stereo camera according to the first embodiment of the present invention;

FIG. 3 is an explanatory view showing a left image according to the first embodiment of the present invention;

FIGS. 4A to 4C are explanatory views for explaining how to extract an object region according to the first embodiment of the present invention;

FIG. 5 is an explanatory view showing an object model generation according to the first embodiment of the present invention;

FIG. 6 is an explanatory view for explaining the processing of a virtual image generating portion according to the first embodiment of the present invention;

FIG. 7 is a block diagram showing a construction of a three-dimensional model generating apparatus and display apparatus of a three-dimensional model according to a second embodiment of the present invention;

FIGS. 8A and 8B are explanatory views for explaining the photographing method used in the three-dimensional model generating apparatus and display apparatus of a three-dimensional model according to the second embodiment of the present invention;

FIG. 9 is a flowchart showing processing algorithm of a model generating program according to the present embodiment;

FIG. 10 is a flowchart showing processing algorithm of a model generating program according to the present embodiment;

FIG. 11 is a block diagram showing a construction of an image processing apparatus according to a third embodiment of the present invention;

FIG. 12 is a flowchart showing steps of three-dimensional image displaying processing according to the third embodiment;

FIG. 13 is an explanatory view showing a method of photographing an object image according to the third embodiment;

FIG. 14 is an explanatory view showing the movement of camera viewpoints in the photographing method shown in FIG. 13;

FIG. 15 is an explanatory view for explaining calculation of a three-dimensional coordinates calculated by a method utilizing the theory of trigonometry, based on the position of the corresponding points in the images g1 and g2 and movement parameters;

FIG. 16 is a table showing characteristics of a partial model generated in the third embodiment;

FIG. 17 is an explanatory view showing viewpoint movement ranges of an object model according to the third embodiment;

FIG. 18 is a displayed view of a three-dimensional model according to the third embodiment;

FIG. 19 is a table showing characteristics of a partial model generated according to a fourth embodiment of the present invention; and

FIG. 20 is an explanatory view showing viewpoint movement ranges of an object model according to the fourth embodiment.

### DETAILED DESCRIPTION OF THE PREFERRED EMBODIMENTS

Preferred embodiments of the present invention will be described in detail in accordance with the accompanying drawings.

### First Embodiment

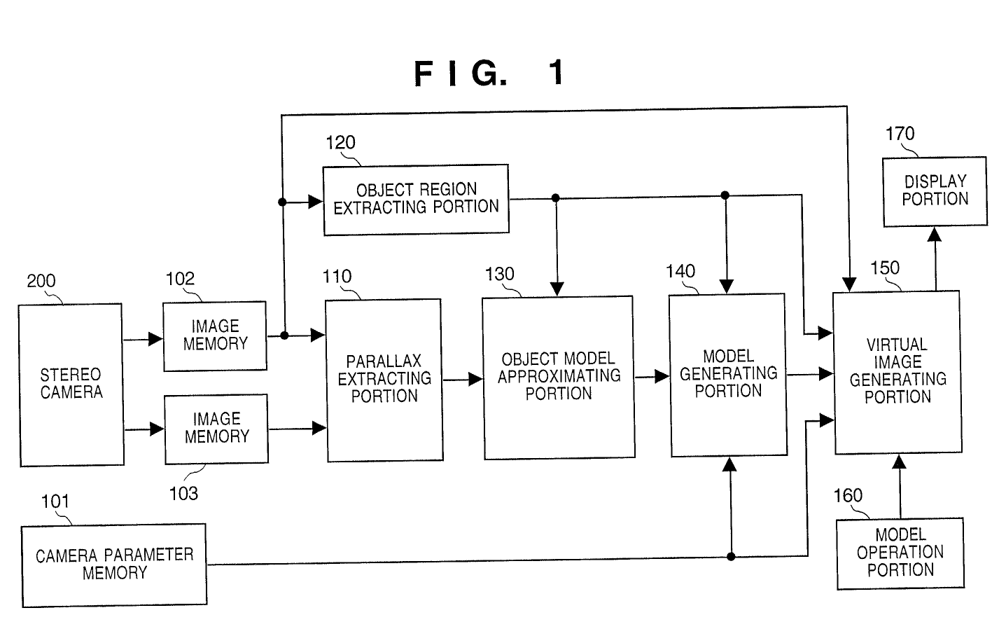

FIG. 1 shows a construction of a three-dimensional model generating apparatus and a display apparatus of a three-dimensional model according to the first embodiment of the present invention. Reference numeral 200 denotes a stereo camera which outputs image data of left and right systems. Reference numeral 101 denotes a camera parameter memory for storing camera parameters of the left and right images photographed by the stereo camera 200. Reference numerals 102 and 103 are image memories for respectively storing image data corresponding to one frame for the left and the right systems, which are photographed by the stereo camera 200. Reference numeral 110 denotes a parallax extracting portion which extracts parallax distributions of the left and the right image data stored in the image memories 102 and 103 as parallax distributions data and outputs the extracted data. Reference numeral 120 denotes an object region extracting portion which extracts an object region from the left image data stored in the image memory 102 and outputs the extracted data. Reference numeral 130 denotes an object model approximating portion which performs approximation for generating a model of an object by using parallax in object regions, based on the parallax distributions data outputted by the parallax extracting portion 110 and the object region outputted by the object region extracting portion 120, and outputs a model form and parameters. Reference numeral 140 denotes a model generating portion which generates and outputs model data of a three-dimensional scene based on the model form of an object and parameters outputted by the object model approximating portion 130, camera parameters stored in the camera parameter memory 101 and outputs of the object region extracting portion 120.

Reference numeral 150 denotes a virtual image generating portion which generates an image to be displayed in accordance with data indicative of shifting and rotating operation in the three-dimensional space instructed through a model operation portion 160, based on the left image data stored in the image memory 102, the object region outputted by the object region extracting portion 120 and the model data of three-dimensional scene outputted by the model generating portion 140. A display portion 170 displays on a display apparatus image data outputted by the virtual image generating portion.

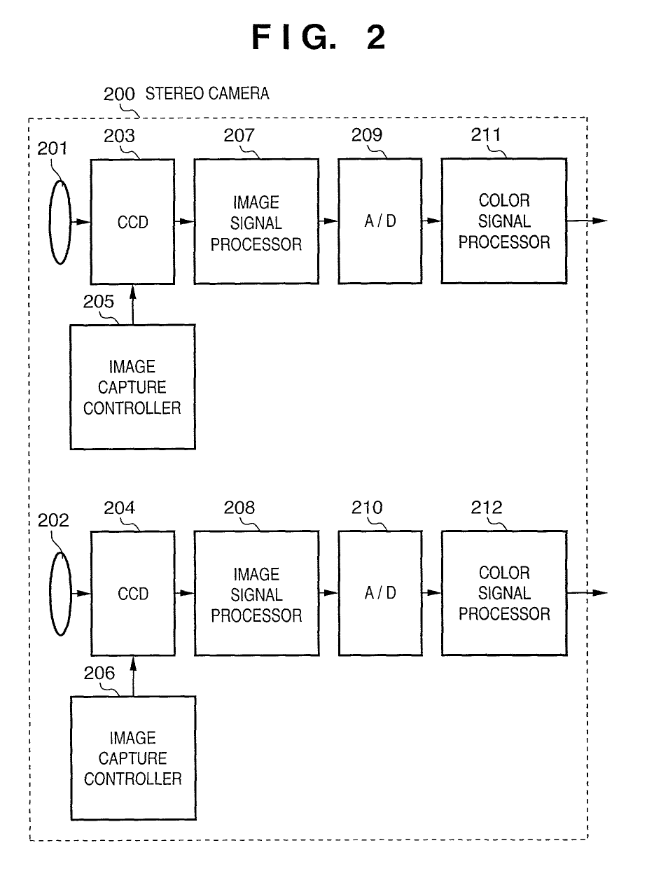

FIG. 2 shows a construction of the stereo camera 200. Reference numeral 201 and 202 respectively denote lenses which photograph stereo images from two viewpoints. Reference numeral 203 and 204 respectively denote an image sensor, e.g., CCD or the like, which captures an image as electrical signals. These two image sensing systems are arranged such that the optical axis of respective image sensing lenses are parallel. Reference numerals 205 and 206 respectively denote image capture controllers which control image capturing performed by the image sensors 203 and 204. Reference numerals 207 and 208 respectively denote image signal processors which maintain electrical signals sent by the image sensors 203 and 204 and form image signals, automatically control gains of the image signals, perform tone correction and output the corrected image data. Reference numerals 209 and 210 respectively denote A/D converters which convert analogue signals outputted by the image signal processors 207 and 208 into digital signals and output digital image data. Reference numerals 211 and 212 respectively denote color signal processors which output digital image data (hereinafter referred to as image data), outputted by the A/D converters 209 and 210, for one frame where each pixel has 24 bits of R, G and B data. The components e.g., the lenses 201 and 202, and image sensors 203 and 204 have the same characteristics for the left and right.

Hereinafter, the three-dimensional model generating apparatus and operation of the display apparatus of the three-dimensional model according to the present embodiment will be described. When a photographer turns on a power switch on a camera (not shown), the image capture controller 205 performs controlling such that an image seen from the right viewpoint of an object, whose image is formed on the image sensor 203, is captured as electrical signals through the lens 201. The captured image signals are processed by the image signal processor 207, A/D converter 209 and color signal processor 211, and right image data is obtained. Similarly, the image capture controller 206 performs controlling such that an image seen from the left viewpoint of the object, whose image is formed on the image sensor 204, is captured as electrical signals through the lens 202. The captured image signals are processed by the image signal processor 208, A/D converter 210 and color signal processor 212, and left image data is obtained. These two image data obtained in the above manner are outputted from the stereo camera 200 as image data photographed at the same timing, in accordance with synchronization signals outputted by a synchronization signal generator (not shown). When a shutter button (not shown) is depressed, the left and right image data outputted by the stereo camera 200 are respectively stored in the image memories 102 and 103. Among the left and right image data, the left image data stored in the image memory 102 is outputted to the virtual image generating portion 150. The virtual image generating portion 150 outputs the left image data to the display portion 170 without further processing. As a result, the left image of the object photographed by the stereo camera 200 is displayed on a display apparatus.

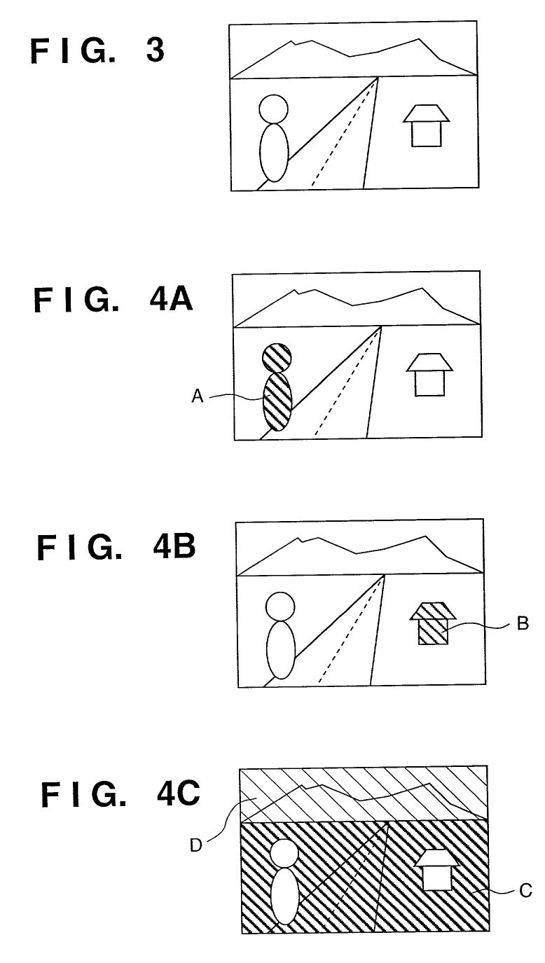

When the left image photographed by the stereo camera 200 is displayed on the display apparatus, a user selects a desired object region of the left image by using an interface such as a cursor or the like. FIG. 3 shows an example of the left image. FIGS. 4A, 4B and 4C show object regions extracted from the image in FIG. 3. In the example shown in FIGS. 4A to 4C, four object regions A, B, C and D are extracted. At this stage, the object region extracting portion 120 obtains and outputs the image region by using an interface such as a cursor or the like and performs controlling for displaying the image region on the display apparatus.

Meanwhile, the parallax extracting portion 110 divides a left image, serving as a reference, into small rectangular regions using the left image data and right image data stored in the image memories 102 and 103 respectively. A region of a right image having the least difference of image data is searched in each of the small regions and extracted as a corresponding region. The extracted result in each of the regions is outputted as data indicative of horizontal deviation amount (hereinafter referred to as parallax).

The object model approximating portion 130 extracts the parallax distributions outputted by the parallax extracting portion 110 with respect to each of the object regions extracted by the object regions extracting portion 120, and performs approximation for generating the three-dimensional model. In the present embodiment, a plane model is adopted as a model form. Assume that pixel coordinates in the image is (u, v) (note that the horizontal and vertical directions of the image sensing surface of the image sensor are respectively u axis and v axis, and a point of intersection between the image sensing surface and the optical axis is the origin), and a parallax at the position (u, v) is d. In the case of a plane model, the parallax distributions of an object is approximated by the following equation:

1/d k0+k1·u+k2·v (1)

More specifically, plane parameters k0, k1 and k2 are approximated by least squares method using a group (u, v, d) (more than three groups) of the object region (note that in a case where d=0, an appropriate large value is set for 1/d). The object model approximating portion 130 executes the above calculation for each of the object regions A, B, C and D, and outputs a model form indicative of a plane model, and parameters k0, k1 and k2.

Next, the model generating portion 140 generates model data of the object based on the model form and parameters outputted by the object model approximating portion 130 for each object region, camera parameters stored in the camera parameter memory 101, and object regions outputted by the object region extracting portion 120.

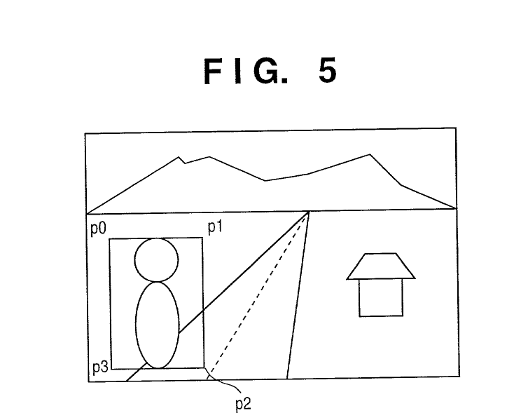

The model generating portion 140 sets four vertexes of a rectangular region surrounding the object region as the coordinates in the image, based on the output of the object region extracting portion 120. Vertexes of the object region A shown as an example in FIG. 4 is indicated as p0, p1, p2 and p3 in FIG. 5. (1/d) is obtained based on the coordinates (u, v) of each vertex in the image and the parameters k0, k1 and k2 of the object model approximating portion 130.

Then, coordinates (x, y, z) of each vertex (a left-handed system where the horizontal and vertical directions of the image sensor are x axis and y axis respectively, and the optical-axis direction is z axis) in a three-dimensional space is obtained based on the camera parameters. Herein, the three-dimensional space has the viewpoint of the left image sensing system as an origin. Note that the camera parameters include a distance b (hereinafter referred to as a base length) between the centers of lenses (viewpoint) of two image sensing systems, a focal point distance f of the image sensing systems (distance from a viewpoint to an image sensing surface along an optical axis of the image sensing system), and pixel space p of image data. The coordinates (x, y, z) in the three-dimensional space is obtained by the following equation (2).

x=(b/d)·u

y=(b/d)·v

z=(f·b)/(p·d) (2)

The model generating portion 140 outputs, as model data of the object, coordinates of the four vertexes obtained by the equation (2), coordinates in the image corresponding to each of the vertex coordinates, and an object index indicative of the association with an object, for each of the object regions.

Next, the virtual image generating portion 150 arranges, in a world coordinates system, model data of each object outputted by the model generating portion 140 and the virtual camera, and performs rendering of an image by perspective projection on an image surface of the virtual camera. In the arrangement of the object model, a plane is generated on the world coordinates system by the group of vertex data. Using the coordinates in the image corresponding to each vertex, mapping is performed on the generated plane by using a part of the left image data as a texture. Furthermore, an object region corresponding to the plane is obtained by using the object index and the surface of the plane other than the object region is set to be transparent.

It is set such that an initial position of the virtual camera coincides with the origin of the world coordinates system and the direction of the virtual camera is set such that the x, y and z axes of the virtual camera coincide with three coordinates axes of the world coordinates system. Moreover, the focal distance of the virtual camera is set so as to coincide with a focal distance, stored as a camera parameter in the camera parameter memory 101. Furthermore, the size of the image surface of the virtual camera is set so as to coincide with the size of the image surface obtained by the size of image data and pixel space, stored as camera parameters in the camera parameter memory 101.

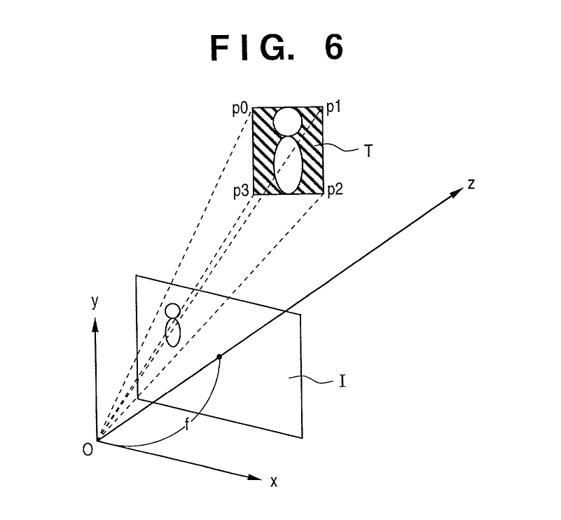

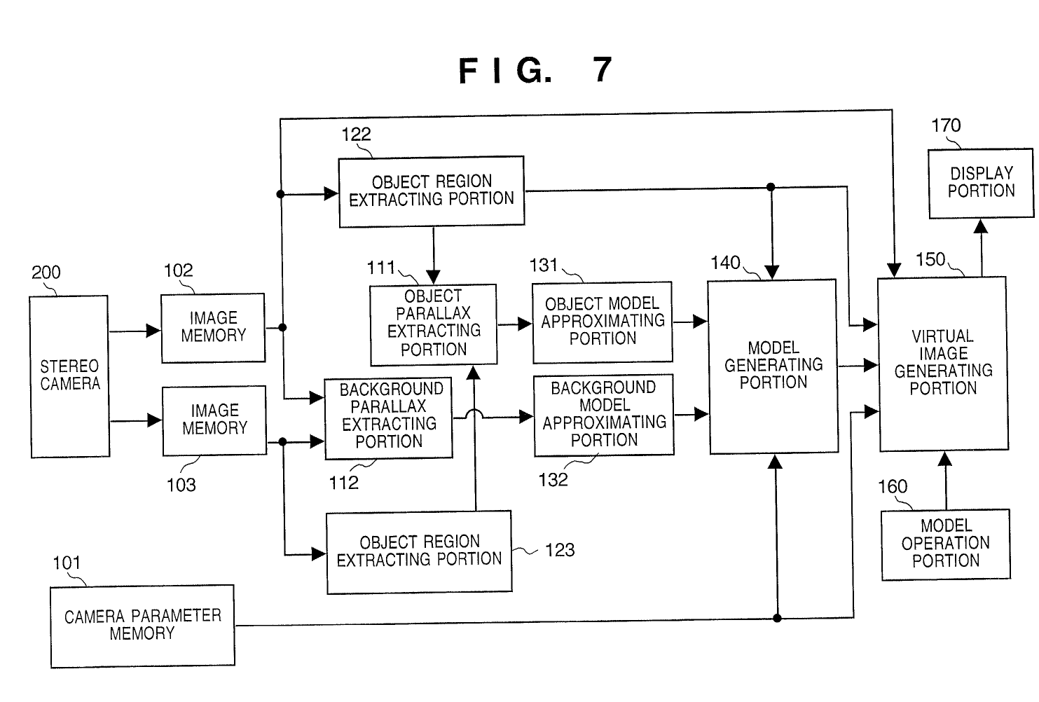

FIG. 6 shows setting of the object model and virtual camera with respect to the object region A shown in FIG. 4A. In FIG. 6, x, y and z denote three axes of the world coordinates system; O denotes the origin of the coordinates system and a viewpoint of the virtual camera; I denotes the image surface of the virtual camera; p0, p1, p2 and p3 denote vertexes which are indicated by the same reference numerals in FIG. 5; T denotes an area which is set as a transparent area based on the object region extracted by the object region extracting portion 120. In the present embodiment, other objects B, C and D are simultaneously set and rendered in the image surface. The image data rendered by means of perspective projection on the image surface I of the virtual camera is outputted to the display portion 170 and an initial image is displayed on a display apparatus.

The model operation portion 160 transmits instructions related to shifting and rotating of the virtual camera to the virtual image generating portion 150 through an interface such as keyboard or mouse or the like. In accordance with the instruction, the virtual image generating portion 150 moves the position of the virtual camera or rotates the direction of the camera, then renders the object model again on the image surface of the virtual camera. As a result, an image reflecting the shift/rotation of the virtual camera instructed by the model operation portion 160 is displayed on a display apparatus.

By the above-described processing, it is possible to generate a model of a three-dimensional scene based on images photographed by a camera, and display the generated three-dimensional scene as if a user is walking through the scene. The model generation of the three-dimensional scene is realized by merely designating a region of an object in the image, which is quite simple and easy.

Moreover, since the area other than the object region is set to be transparent at the time of setting the object model by the virtual image generating portion 150, the outline of object in a displayed image becomes precise, reflecting the outline of the object region extracted, without necessitating precise generation of a three-dimensional form of the object model. In the model generating portion 140 according to the present embodiment, the plane serving as an object model is set as a rectangular region defined by four vertexes surrounding the object region. When the image is displayed by the virtual image generating portion 150, the outline of the object is referred. Therefore, a precise object image can be obtained. In other words, an object model may be generated somewhat roughly, and the amount of data can be reduced. As described above, because the outline of an object is referred to when an image is displayed, the amount of data of the object model can be reduced; as a result, image generation can be performed at high speed.

Note that in the present embodiment, approximation of the object model is performed individually for the object regions A, B, C and D. However, approximation may be performed simultaneously on a plurality of object regions to generate a model with a given restriction condition which takes into consideration of the connecting portions between each of the object regions. Furthermore, when approximation is performed on an object region to generate a model, the object region may be divided and the divided regions may be approximated as a connected model. For instance, in a case where the regions C and D in FIG. 4C are regarded as one object region, these regions are approximated as a connected model.

In the present embodiment, a plane model is used as an approximation model of an object. However, approximation may be performed by, for instance, the following model:

d=k0+k1·u+k2·v (3)

Alternatively, approximation may be performed by a model having a quadratic form as follows:

d=k0+k1·u+k2·v+k3·uv+k4·u2+k5·v² (4)

Alternatively, a three-dimensional model of an object may be approximated by utilizing a spline surface or the like. It is appropriate to use an approximation model form which is close to an object in reality. A most appropriate model form may be selected from the parallax distributions of the object regions. In this case, a model form is set for each object region.

Moreover, according to the present embodiment, shift and rotation of the camera is enabled as the operation of the virtual camera. Additionally, zoom operation may be combined. In such case, the focal distance of the virtual camera is changed in accordance with zooming operation and an object model is rendered again.

Furthermore, according to the present embodiment, a virtual image generated by the virtual image generating portion 150 is displayed on a normal display apparatus. However, for instance, a stereoscopic image may be displayed by a three-dimensional display apparatus which enables to view the left and right images respectively with the left and right eyes. Such three-dimensional display apparatus realizes a stereoscopic image by displaying the left and right images at alternate timing and allowing a user to view the images with liquid crystal shutter glasses synchronizing the display. In order to realize this, virtual cameras of the virtual image generating portion 150 are set as a stereo camera having viewpoints apart from each other by a base length b, and an object model is rendered on the image surfaces of two image sensing systems. Then, the generated two images are displayed by the display portion 170 at alternate timing.

### Second Embodiment

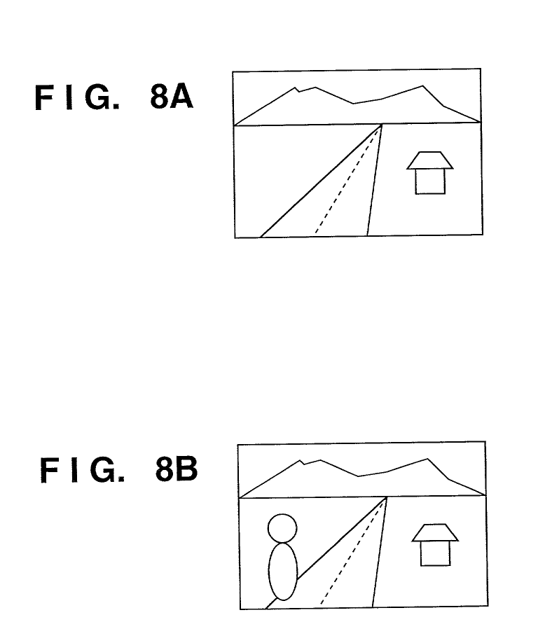

FIG. 7 shows a construction of a three-dimensional model generating apparatus and display apparatus of a three-dimensional model according to the second embodiment of the present invention. In FIG. 7, components having reference numerals same as that in FIG. 1 have the functions equivalent to that of the first embodiment. In the second embodiment, the stereo camera 200 photographs an image of a background only, then photographs an image with an object, and processing is performed using these images. FIGS. 8A and 8B show two left images obtained by photographing the image twice by the stereo camera 200. FIG. 8A shows a background image, and FIG. 8B shows an image where an object is added to the background shown in FIG. 8A. In the image memories 102 and 103, the left and right image data for the two photographing operations are stored. Thus, the image memories 102 and 103 respectively have a capacity for storing two images. Reference numerals 122 and 123 denote an object region extracting portion which extracts an object region from image data of the two images stored in the image memories 102 and 103, and outputs the object image and object region. Reference numeral 111 denotes an object parallax extracting portion which extracts parallax distributions of an object region from the left and right object images outputted by the object region extracting portions 122 and 123 and outputs the extracted data. Reference numeral 112 denotes a background parallax extracting portion which extracts parallax distributions of a background from the left and right background images stored in the image memories 102 and 103 and outputs the extracted data. Reference numeral 131 denotes an object model approximating portion which performs model approximation of an object based on the parallax distributions of the object outputted by the object parallax extracting portion 111 and outputs a model form and parameters. Reference numeral 132 denotes a background model approximating portion which performs model approximation of a background based on the parallax distributions of the background outputted by the background parallax extracting portion 112 and outputs a model form and parameters.

Hereinafter, operation of the three-dimensional model generating apparatus and display apparatus of a three-dimensional model according to the present embodiment will be described. First, a background image is photographed by the stereo camera 200 and the left and the right background images are respectively stored in the image memories 102 and 103. Similar to the first embodiment of the present invention, the left image data among these image data is displayed on a display apparatus of the display portion 170. Then, an image is photographed with an object and the left and right image data are respectively stored in the image memories 102 and 103.

The object region extracting portions 122 and 123 respectively extract object regions from the two images stored in the image memories 102 and 103. The object region extracting portions 122 and 123 initially obtains a difference between the background image and image including an object, and extracts a region having a larger difference than a predetermined threshold value as a rough object region. An edge image of the image including the object is also obtained. Then, the object regions are connected and spaces are filled based on colors and luminance of the image including object, the outline of the object region is corrected based on the edge image and an object region is extracted. Then, an object image including only the object region and the object is outputted.

Next, the object parallax extracting portion 111 performs processing similar to the parallax extracting portion 110 described in the first embodiment of the present invention, extracts parallax distributions from the left and right object images outputted by the object region extracting portions 122 and 123 and outputs the extracted data. Note that extraction is performed within the object region only. The background parallax extracting portion 112 performs processing similar to the parallax extracting portion 110 described in the first embodiment, extracts parallax distributions of the background from the left and right background images stored in the image memories 102 and 103 and outputs the extracted data.

The object model approximating portion 131 performs model approximation of an object in the similar manner to the object model approximating portion 130 described in the first embodiment, based only on the parallax distributions of the object region outputted by the object parallax extracting portion 111, and as a result, outputs a model form and parameters. The background model approximating portion 132 performs model approximation of the background based on the parallax distributions of the background outputted by the background parallax extracting portion 112, and outputs a model form and parameters. A three-dimensional model of a background is generally difficult to express on a plane. Therefore, it is preferable to employ the connected model described in the first embodiment. The background region is divided based on the parallax distributions of the background. In a case of the background image shown in FIG. 8A, approximation is performed utilizing the divided region as a connected model of planes. Alternatively, approximation may be performed by using a model having a quadratic form or spline surface.

The model generating portion 140, virtual image generating portion 150, model operation portion 160 and display portion 170 operate in the same manner as that of the first embodiment.

By the above-described configuration, a model of a three-dimensional scene can be generated based on images photographed by a camera, making it possible to display the generated three-dimensional scene as if a viewer is walking through the scene. In the present embodiment, the model generation of the three-dimensional scene can be performed automatically. Moreover, since a background image and an image including an object on the background are separately photographed and processed, the background is not hidden by the shadow of the object when the image is displayed.

According to the foregoing embodiment, a model of a three-dimensional scene photographed by the stereo camera 200 can be generated. By generating a plurality of models for the three dimensional scenes and integrating the models of the three-dimensional scenes, it is possible to generate a model of a three-dimensional scene having a wide field of view. For instance, by generating a virtual space of a three-dimensional scene in spherical view and displaying the generated model, a viewer can have a virtual experience in a three-dimensional space close to the reality.

Although the second embodiment does not have a structure to record images generated by the virtual image generating portion 150, to record images in a print medium, the second embodiment may structure such that a user can operate the virtual camera in an arbitrary position and direction using the model operation portion 160 and confirm an image in a desired camera position and direction on the display portion 170.

Furthermore, in the foregoing embodiments, a stereo image is directly obtained from the stereo camera 200 and processing of generating a three-dimensional model is performed. However, the stereo camera may be constructed such that an image photographed by the stereo camera is recorded in a print medium which can be removed from the camera, and the stereo image recorded in the print medium is subjected to processing similar to the images stored in the image memories. Moreover, a stereo image is not limited to those photographed by a stereo camera, but may be substituted with a plurality of images photographed from different viewpoints by an ordinary digital camera.

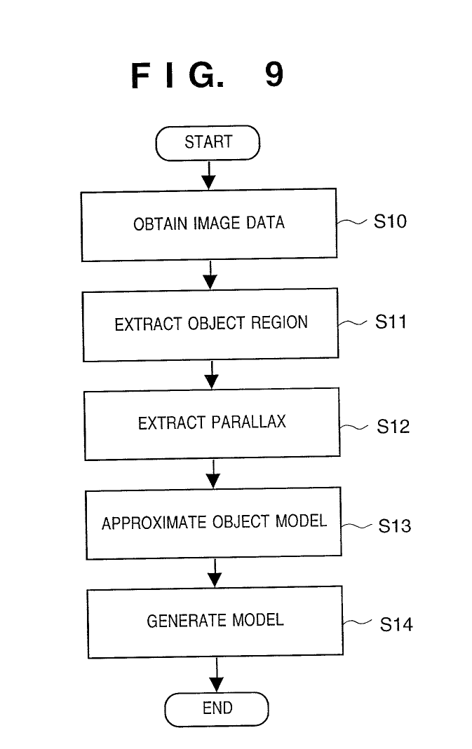

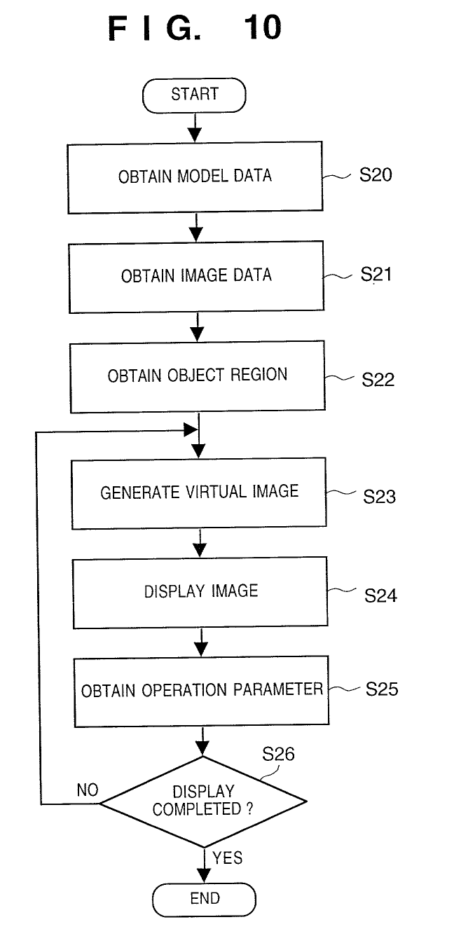

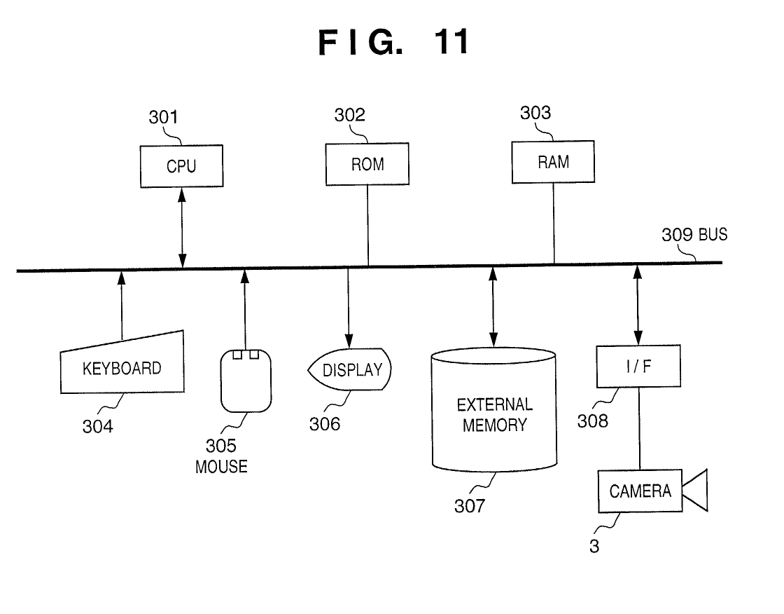

Further, although the foregoing embodiments have been described with an assumption that the apparatus is hardware, programs may be provided by substituting each of the processors with processing modules and may be executed by a computer to perform the aforementioned processing. Hereinafter, an example will be given for a program where the first embodiment of the present invention is substituted with processing modules of software. Note that the following example of the processing program is constructed with a model generating program for generating a three-dimensional model of an object and a model displaying program for displaying the generated model. FIG. 9 shows a processing algorithm of the model generating program; and FIG. 10 shows a processing algorithm of the model displaying program. Operation thereof will be described hereinafter.

First, the model generating program is described.

In step S10, image data is obtained. The image data obtained herein is, for instance, the left and right image data photographed by the stereo camera 200 in the three-dimensional model generating apparatus described in the first embodiment.

Next, in step S11, an object region is extracted from the left image data of the left and right image data obtained in step S10. The processing of extracting the object region is the same as that of the object region extracting portion 120 in the three-dimensional model generating apparatus described in the first embodiment. Also in step S11, the object region extracted is recorded in a memory device of a computer. In a case there are a plurality of object regions, the plurality of object regions are recorded.

Next in step S12, parallax distributions are extracted from the left and right image data obtained in step S10. The processing of extracting the parallax distributions is the same as that of the parallax extracting portion 110 in the three-dimensional model generating apparatus described in the first embodiment.

In step S13, approximation of the three-dimensional model of the object is performed based on the object region extracted in step S11 and the parallax distributions extracted in step S12, then a model form and parameters of the object are outputted. Processing of the object model approximation is the same as that of the object model approximating portion 130 in the three-dimensional model generating apparatus described in the first embodiment.

In step S14, model data of the object is generated based on the object region extracted in step S11 and the form and parameters of the object model outputted in step S13, by utilizing the camera parameters of the image data obtained in step S10. The processing of generating the object model is the same as that of the model generating portion 140 in the three-dimensional model generating apparatus described in the first embodiment. Furthermore, the generated model data of the object is stored in a memory device of a computer. At the same time, image data utilized to generate the model data of the object, and index of the object region data are recorded. The index indicates the file name of each data.

Next, the model displaying program is described.

In step S20, the model data of the object recorded in step S14 is stored in a memory of the processing program.

In step S21, the left image data is obtained from the left and right image data obtained in step S10 by utilizing an index of image data.

Next in step S22, the object region extracted in step S11 is obtained by utilizing index of the object region data and stored in a memory of the processing program.

In step S23, a virtual image is generated based on the model data of the object obtained in step S20, the left image data obtained in step S21 and object region obtained in step S22, by utilizing the camera parameters of the image data obtained in step S21. The processing of generating the virtual image is the same as that of the virtual image generating portion 150 in the three-dimensional model generating apparatus described in the first embodiment.

In step S24, the virtual image generated in step S23 is displayed on a display device of a computer.

In step S25, parameters for user operation e.g., shifting or rotating the virtual camera, inputted through an interface unit such as a keyboard, mouse or the like, are obtained. Then, in step S26, the processing returns to step S23 to perform rendering again. In a case where a parameter indicative of display completion is received at this stage, the processing program ends (step S26).

Although the above example of the processing program is constructed by the model generating program for generating a three-dimensional model of an object and the model displaying program for displaying the generated model, the model generating program may further include an object approximating program (including the processing of steps S10, S11, S12 and S13 in FIG. 9) and a model converting program (including the processing of step S14 in FIG. 9). In this case, approximating parameters are recorded in a memory device of a computer by the object approximating program; the approximating parameter, image data and object region are read by the model converting program to generate a model; and the generated model is transferred to the memory of the model displaying program. By this processing, it is possible to reduce a memory capacity requirement in the computer memory.

According to the above described first and second embodiments, the following effect is attained.

A three-dimensional model, where a user can virtually walk through a three-dimensional space, is generated without complicated operation, by pasting 5, images photographed by a camera to a three-dimensional model as a texture.

The first and second embodiments have described the configuration necessary to generate a three-dimensional space where a user can virtually walk through. In the following third and fourth embodiments, a construction for virtually rotating an object in the three-dimensional space will be described.

### Third Embodiment

FIG. 11 is a block diagram showing a construction of an image processing apparatus according to the third embodiment of the present invention. In FIG. 11, reference numeral 301 denotes a CPU which realizes various processing based on control programs stored in ROM 302 and RAM 303. Reference numeral 302 denotes a ROM where control programs executed by the CPU 301 and various data are stored. Reference numeral 303 denotes a RAM which provides an area for storing control programs, loaded from an external memory device e.g., hard disc or the like, which are executed by the CPU 301, or provides a work area for the CPU 301 to execute various processing.

Reference numeral 304 denotes a keyboard and 305 denotes a pointing device, both provided for inputting various data to the image processing apparatus of the present embodiment. The reference numeral 306 denotes a display which displays a three-dimensional model or the like which will be described later.

Reference numeral 307 denotes an external memory where object image data obtained by photographing operation of a camera 3 or control programs loaded to the RAM 303 to be executed by the CPU 301 are stored. Reference numeral 308 denotes a camera interface utilized mainly to input object image data, obtained by photographing operation of the camera 3, in order to store the object image data in the external memory 307. Reference numeral 309 denotes a bus which interactively connects the above components.

In the embodiment which will be described below, although object image data obtained by photographing operation of the camera 3 is inputted through interface 8, the present invention is not limited to this. For instance, a plurality of photographs of an object may be read by a scanner and inputted as object image data, or an image stored in a CD-ROM or the like may be inputted as object image data.

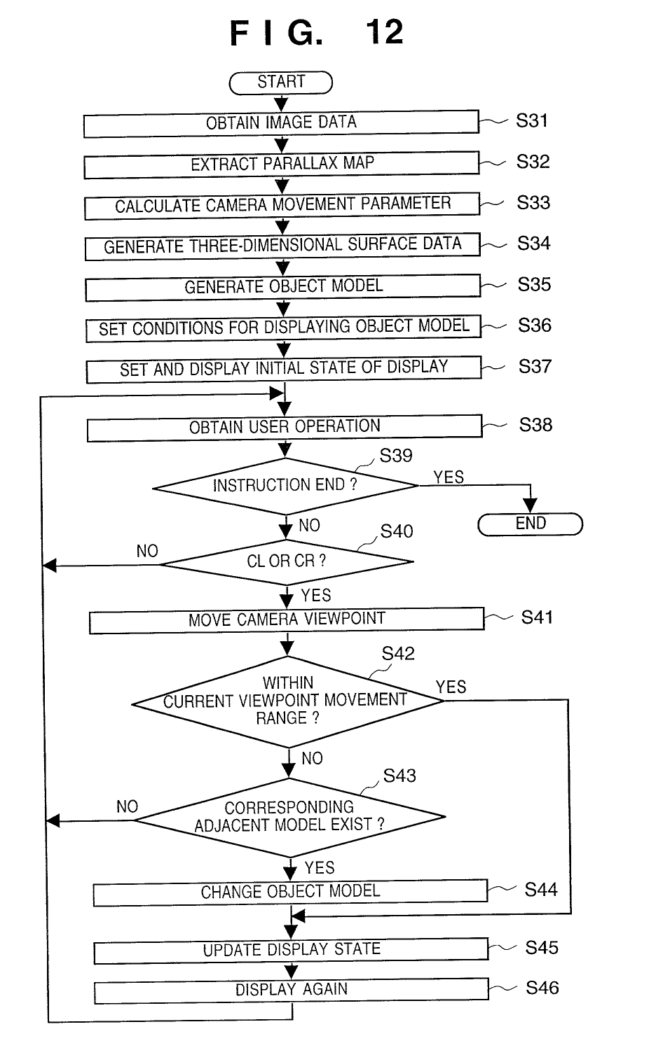

FIG. 12 is a flowchart describing the steps of displaying a three-dimensional image according to the third embodiment. Note that control programs which realize the control steps shown in FIG. 12 are stored in the external memory 307, and are loaded to the RAM 303 when the programs are executed by the CPU 301. Hereinafter, the third embodiment will be described by referring to the flowchart in FIG. 12.

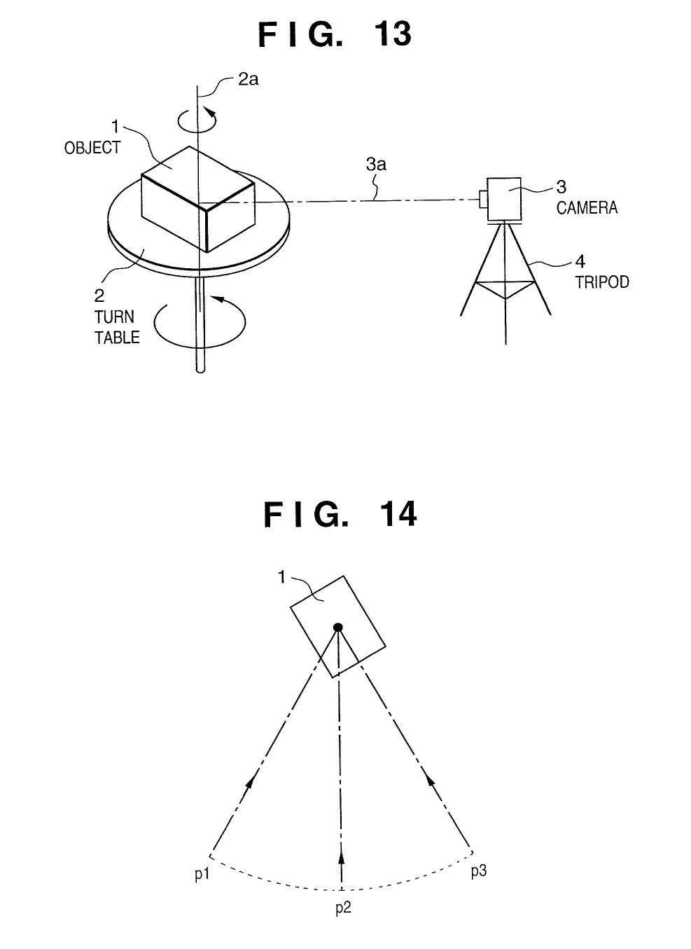

In step S31, an object is photographed by the camera 3 and image data is obtained. Herein, assume that the object is photographed by the method shown in FIG. 13. Note that the present embodiment describes a case where the object is photographed three times from rotational directions. While FIG. 13 shows a case where the object is rotated, FIG. 14 shows a case where the camera rotates around the object. It is apparent that the object image obtained by the operation shown in FIGS. 13 or 14 is equivalent. Referring to FIG. 14, p1, p2 and p3 indicate a camera viewpoint position at the time of photographing operation, and the arrow indicates the optical-axis direction. A plurality of object images obtained by photographing the image at p1, p2 and p3 are stored in the external memory 307, then the following processing is performed. Note that in the following description, the image data obtained by photographing the object at the camera viewpoint positions p1, p2 and p3 will be referred to g1, g2 and g3 respectively.

When an object is photographed by the camera, the processing proceeds to step S32. A parallax map is extracted from adjacent images in step S32. In this example, parallax maps are extracted for the image g1 and image g2, and image g2 and image g3.

Hereinafter, description will be provided on the method of extracting a parallax map from two images. First, one of the images is divided into N×M blocks. In each of the blocks, an area having the most similar image pattern is searched, and the searched area is determined as corresponding regions. A variance of the central positions in the corresponding regions (representation point of the region) in both object images is defined as a parallax vector. The parallax vector is extracted for all the blocks and the extracted vectors are defined as a parallax map. Note that the extraction processing of parallax map is performed between all the adjacent images (in the present embodiment, image g1 and g2, and image g2 and g3).

Next, in step S33, a camera movement parameter between two object images is calculated from the parallax map obtained in step S32. The camera movement parameter includes a parameter Tn indicative of a movement direction of a camera viewpoint position and a parameter R indicative of rotation of a camera in the optical-axis direction.

Note that the method of calculating a camera movement parameter described below is disclosed in “Computer and Robot Vision Volume II,” Chapter 15.5 written by R. M. Haralick and L. G. Shapiro (Addison-Wesley).

A matrix F indicative of corresponding relationship between images is obtained. A position of the representation point (u, v) in each block of an image and a position of the representation point (u′, v′) in the corresponding region of the other image are extracted, and a matrix F which satisfies the following equation (4) is obtained by the least squares method.

x′^{T} Fx=0 (4)

Where x=(u, v, 1)^{T}, x′=(u′, v′, 1)T₁ and F is a 3×3 matrix having rank 2.

A three-dimensional rotation matrix R and a unit movement vector Tn=T/|T| of the camera is calculated from the matrix F (note that T is a movement vector). The processing for calculating the camera movement parameters is performed for all the adjacent images (in the present embodiment, image g1 and g2, and image g2 and g3). The movement parameters of the images g1 and g2 are defined as Tn1 and R1, and the movement parameters of the images g2 and g3 are defined as Tn2 and R2.

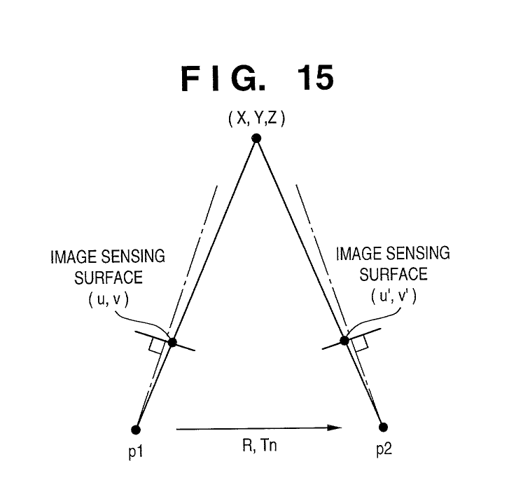

In step S34, three-dimensional surface data (three-dimensional model) is generated based on the parallax map and camera movement parameters. The three-dimensional surface data is constructed by vertex data indicative of three-dimensional positions of a plurality of vertexes which express an object with a plurality of triangles, and data indicative of arrays of the triangle data consisting of three vertex data. Each of the vertex data has, in addition to the three-dimensional coordinates indicative of the positions of vertexes, two of the two-dimensional coordinates indicative of the positions of vertexes in the original two object images. This is utilized later on to obtain texture from the original image data in texture mapping processing where a three-dimensional image is displayed. Three-dimensional coordinates (X, Y, Z) of the vertexes of each triangle which constitutes the three-dimensional surface data are calculated by the method utilizing the theory of trigonometry shown in FIG. 15, based on the positions of the corresponding points in the images g1 and g2, and the movement parameters.

Note that because T, an element of the camera movement parameter, cannot be obtained as an absolute value, the three-dimensional surface data is obtained as a relative value which represents the shape of an object. The processing for generating the three-dimensional surface data is performed for all the adjacent images (in the present embodiment, images g1 and g2, and images g2 and g3). Note that in the following description, three-dimensional surface data generated from the images g1 and g2 is defined as S1, and three-dimensional surface data generated from the images g2 and g3 is defined as S2.

In step S35, an object model constructed by a plurality of partial models is generated based on the plurality of three-dimensional surface data obtained in step S34. In the present embodiment, the object model consists of four partial models, M11, M12, M22 and M23. Note that the partial models M11 and M12 are generated from the three-dimensional surface data S1, while M22 and M23 are generated from the three-dimensional surface data S2.

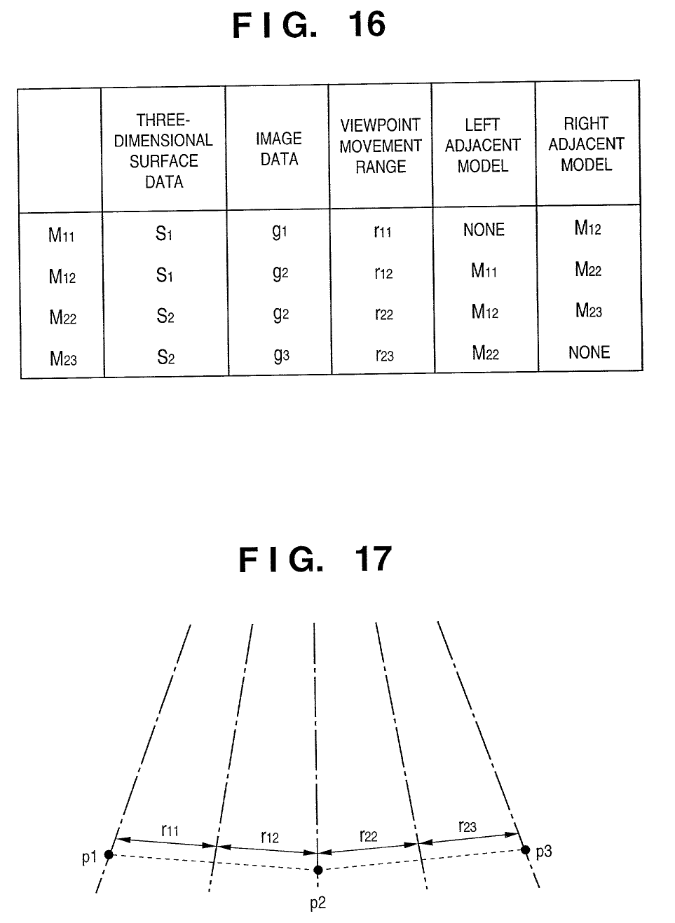

FIG. 16 is a table showing the characteristics of a partial model generated according to the third embodiment. Herein, for instance, the partial model M11 has, as its three-dimensional surface data, a three-dimensional structure based on vertex data of the three-dimensional surface data S1. An image pattern of a triangle area corresponding to image g1 is pasted to each triangle data of the partial model M11. In the similar manner, the partial models M12, m22 and M23 have three-dimensional structures based on the three-dimensional surface data S1, S2 and S2 respectively, and image patterns of the images g2, g2 and g3 are pasted respectively.

In step S36, a displaying condition of an object model is set. Herein, an amount of change in the camera movement parameters, viewpoint movement range and adjacent models in the left and right shown in FIG. 16 are set.

In the present embodiment, the amount of change in the camera movement parameters is set such that a viewpoint of a camera moves along the straight line which connects the camera viewpoint positions p1 and p2, or p2 and p3 as shown in FIG. 14, and that an image is generated to be coherent with the amount of viewpoint movement between two viewpoint positions. Assuming that the amount of change in viewpoint movement is dT, the rotational amount for each display is dQ, and the rotational amount of the camera obtained from the three-dimensional rotation matrix R is Q, the amount of change in the camera movement parameters is set so as to satisfy the following equation (5). Note that the amount of change in the camera movement parameters for displaying is set for each of the three-dimensional surface data.

Tn/dT=Q/dQ (5)

Furthermore, viewpoint movement ranges (r11, r12, r22 and r23) in FIG. 16 are set for each of the partial models of the object (M11, M12, M22 and M23). Since the present embodiment displays an image in one-dimensional direction, the viewpoint positions at both ends of the display range are set. With regard to the adjacent models which refer to the same three-dimensional surface data (e.g., M11 and M12 refer to the three-dimensional surface data S1), the viewpoint movement range is set such that the partial model is changed at the intermediate position of the viewpoints.

Since each of the three-dimensional surface data (S1 and S2) has an independent three-dimensional coordinates system defined respectively by images at two viewpoints, coordinates of the set positions in the viewpoint movement range have different reference coordinates for each three-dimensional surface data. More specifically, in the present embodiment, the groups of M11 and M12, and M22 and M23 have viewpoint movement range data in the same coordinates system. Furthermore, as shown in FIG. 16, adjacent models for the left and right are set for each of the partial models. Note that NONE in FIG. 16 indicates there is no adjacent model exist. By the foregoing setting, the object model is displayed in the viewpoint positions and viewpoint movement ranges as shown in FIG. 17. The broken line in FIG. 17 indicates the locus of the camera viewpoint at the time of displaying.

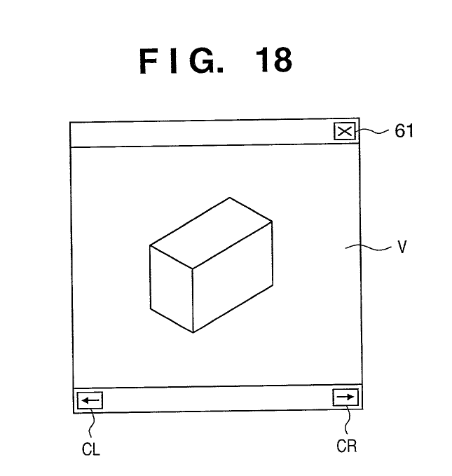

In the foregoing manner, conditions for displaying the object model are set. Next in step S37, the initial state for displaying is set and displayed. Herein, a window for displaying the image is generated and the generated window is displayed on the screen of the display 306. The window includes an image display portion and object operation portion. The window is generated by means of perspective projection of an image of the partial model M22 (i.e., the image g2), in the initial state seen from the viewpoint position p2 shown in FIG. 17. Note that the perspective projection is a well-known projection technique in 3-D computer graphics. In order to generate an image by perspective projection based on an image pattern pasted on each triangle region of the partial model, the technique of Texture Mapping described in “Computer Graphics: Principles and Practice, 2nd Edition in C” pp. 741-744, by Foley et al. (Addison-Wesley) is used. The generated image is rendered in a display memory and displayed in a display 107 serving as an image display portion. This is shown in FIG. 18. FIG. 18 shows the state where a three-dimensional model is displayed according to the present embodiment.

Referring to FIG. 18, reference letter V denotes an image display portion, CL and CR indicate an object operation portion where a user can instruct an object to rotate to the left or to the right. Button 61 in the top right corner denotes an end button for ending the display of the three-dimensional model.

In step S38, user operation is obtained. In a case where the obtained user operation is an instruction to end (e.g., end button 61 is clicked), the present processing ends in step S39. In a case where the obtained user operation indicates that the object operation portion CL or CR is clicked, the processing proceeds from step S40 to step S41.

In step S41, the camera viewpoint is shifted by clicking CL or CR, and determination is made as to a viewpoint movement range in which the present camera viewpoint is included. More specifically, from the camera viewpoint position and direction of the current displaying conditions, the camera viewpoint position and direction are changed in the direction designated by the user by the amount of change in the camera movement parameter. Then, a viewpoint movement range in which the camera viewpoint position exists is determined.

In step S42, it is determined whether or not the viewpoint position indicated by the new displaying conditions is within the viewpoint movement range of the partial model being displayed at present. If it is within the range, the processing proceeds to step S45, otherwise the processing proceeds to step S43.

In a case where the new displaying condition exceeds the current viewpoint movement range, adjacent models set for the current viewpoint movement range are referred to in step S43 (left adjacent model and right adjacent model in FIG. 16 are referred), and determination is made whether or not a partial model corresponding to the new viewpoint movement range can be found. If an adjacent partial model is found, the processing proceeds to step S44 where the present partial model is changed to the adjacent partial model. Meanwhile if the adjacent partial model cannot be found, display data is not updated and the processing returns to step S38. Note that a message, indicating that the stereoscopic model cannot be displayed, may be sent to a user.

For instance, in a case where a user instructs rotation of an object to the left direction, determination is made as to whether or not the right adjacent model can be found, and in a case where a user instructs rotation of an object to the right direction, determination is made as to whether or not the left adjacent model can be found, then the model is changed. Assume a case where the current camera viewpoint position is at p1 (viewpoint movement range is r11) and a user instructs to rotate the object to the right (CR is clicked). Since the left adjacent model is “NONE”, indicating that there is no adjacent model, the present model is not changed and the display data is not updated.

In step S45, the displaying state is updated so as to be coherent with the new camera viewpoint position and direction obtained in step S41. At this stage, if a partial model is changed, the coordinates system is switched (e.g., when a model is changed from model M22 to M12, the coordinates system is switched from S2 to S1). When the coordinates system is switched, the viewpoint position and direction of the camera are updated to end data, indicative of the end of the viewpoint movement range set in advance (e.g., when a model is changed from M22 to the left adjacent model M12, the viewpoint position and direction of camera are changed to the right end of the viewpoint movement range r12 in the coordinates system for the three-dimensional surface data S1 of M12).

In step S46, a partial model to be displayed is generated by perspective projection of the image seen from the camera viewpoint position and direction that have been set. The generated partial model is rendered again in the display memory and displayed on the image display portion (display 306). Then, the processing returns to step S38 where user operation is obtained.

As set forth above, according to the third embodiment, three-dimensional surface data of an object is generated from the adjacent two object images, and a partial model is generated by pasting on the generated three-dimensional surface data, an image pattern obtained from one of the two object images. The partial model is prepared for each pair of object images, and based on a designated viewpoint position, a partial model employed is switched. Accordingly, even if relatively a small number of object images are provided, an object image in the intermediate position and direction of photographed images can be displayed in three dimensions without unrealistic impression.

Moreover, since the number of image data is relatively small, a necessary image memory capacity may be small. Furthermore, since three-dimensional surface data of an object is generated for each of the adjacent object images and an image pattern to be pasted is changed in accordance with a displayed viewpoint position, a natural three-dimensional image of an object having little image distortion can be obtained, without necessitating highly precise three-dimensional surface data of the object.

### Fourth Embodiment

In the foregoing third embodiment, an image pattern to be pasted on three-dimensional surface data of an object, generated from adjacent images, is changed for each of the image data g1, g2 and g3 in accordance with a viewpoint position at the time of displaying. In comparison, in the fourth embodiment, two original image patterns are pasted on top of each other (mixed) to one three-dimensional surface data, and rendering is performed.

Note that the construction of an image processing apparatus according to the fourth embodiment is similar to that of the third embodiment. Therefore, description will be omitted. Hereinafter, operation of the fourth embodiment will be described by referring to the flowchart in FIG. 12.

In the processing shown in FIG. 12, steps S11 to S34, i.e., the processing for generating three-dimensional surface data of an object, are similar to that in the first embodiment. Thus, hereinafter description will be provided on processing subsequent to step S34 where a three-dimensional image is displayed.

In step S35, an object model is generated from a plurality of three-dimensional surface data. In the fourth embodiment, an object model consists of two partial models M1 and M2. Characteristics of each of the partial models are shown in FIG. 19. Herein, for instance, the partial model M1 has a three-dimensional structure based on the vertex data of the three-dimensional surface data S1. An image pattern of a triangle region in the image g1 corresponding to respective vertexes, and an image pattern of a triangle region in the image g2 corresponding to respective vertexes are mixed and pasted to each triangle data of the three-dimensional surface data. Similarly, for the partial model M2, image patterns of the images g2 and g3 are pasted on the three-dimensional surface data S2.

In step S36, displaying conditions of an object model is set. Herein, the amount of change in camera movement parameters is set similar to the third embodiment. As shown in FIG. 19, viewpoint movement ranges r1 and r2 are set for the partial models M1 and M2. Note that the viewpoint positions (any of p1, p2 or p3) at the time of photographing the two images as shown in FIG. 10 are set for viewpoint positions at both ends of the viewpoint movement range. Moreover, the left and right adjacent models are set for each partial model as shown in FIG. 19.

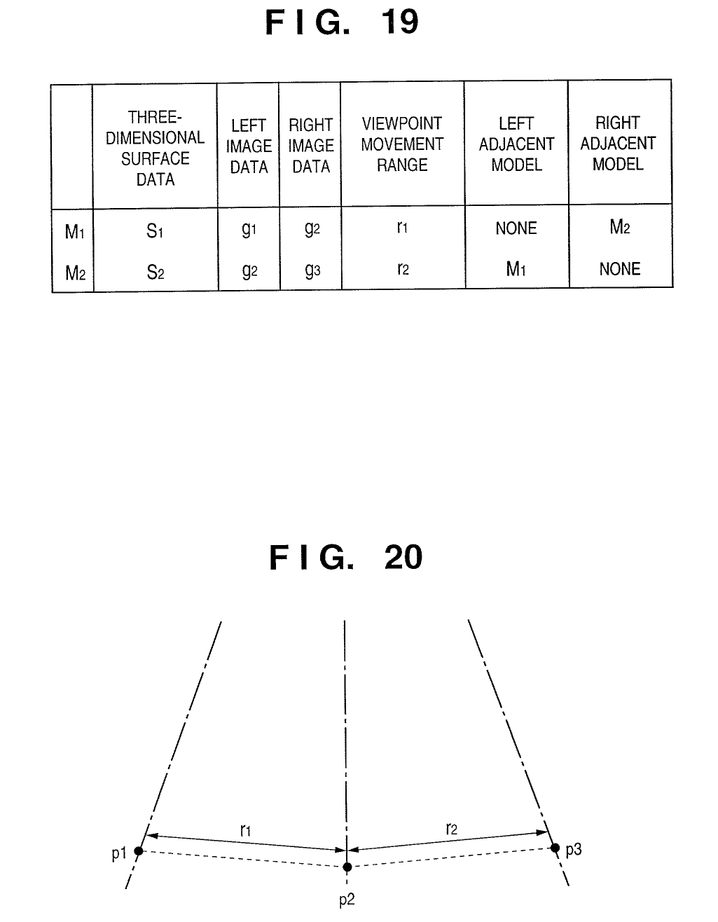

In step S37, the initial state of displaying is set and displayed. In the present embodiment, an image (i.e., image g2) of the partial model M2 seen from the viewpoint position p2 in FIG. 20 is generated by the perspective projection, the generated image is rendered in the memory provided for display data and displayed on the image display portion 306.

In step S38, user operation is obtained. In a case where the obtained user operation is an instruction to end (e.g., end button 61 is clicked), the present processing ends in step S39. In a case where the obtained user operation indicates that the object operation portion CL or CR is clicked, the processing proceeds from step S40 to step S41.

In step S41, the camera viewpoint is shifted by clicking CL or CR, and determination is made as to a viewpoint movement range in which the present camera viewpoint is included. More specifically, from the camera viewpoint position and direction of the current displaying conditions, the camera viewpoint position and direction are changed in the direction designated by the user by the amount of change in the camera movement parameter. Then, a viewpoint movement range in which the camera viewpoint position exists is determined.

In step S42, it is determined whether or not the viewpoint position indicated by the new displaying conditions is within the viewpoint movement range of the partial model being displayed at present. If it is within the range, the processing proceeds to step S45, otherwise the processing proceeds to step S43.

In a case where the new displaying condition exceeds the current viewpoint movement range, adjacent models set for the current viewpoint movement range are referred to in step S43 (left adjacent model and right adjacent model in FIG. 19 are referred), and determination is made whether or not a partial model corresponding to the new viewpoint movement range can be found. If an adjacent partial model is found, the processing proceeds to step S44 where the present partial model is changed to the adjacent partial model. Meanwhile if the adjacent partial model cannot be found, display data is not updated and the processing returns to step S38. Note that a message, indicating that the stereoscopic model cannot be displayed, may be sent to a user.

For instance, in a case where a user instructs rotation of an object to the left direction, determination is made as to whether or not the right adjacent model can be found, and in a case where a user instructs rotation of an object to the right direction, determination is made as to whether or not the left adjacent model can be found, then the model is changed. Assume a case where the current camera viewpoint position is at p1 (viewpoint movement range is r11) and a user instructs to rotate the object to the right (CR is clicked). Since the left adjacent model is “NONE”, indicating that there is no adjacent model, the present model is not changed and the display data is not updated.

In step S45, the displaying state is updated so as to be coherent with the new camera viewpoint position and direction obtained in step S41. At this stage, if a coordinates system is switched in response to the changing of a partial model (e.g., when a partial model is changed from model M2 to M1), the viewpoint position and direction of the camera are updated to end data, indicative of the end of the viewpoint movement range set in advance (e.g., when a partial model is changed from M2 to the left adjacent model M1, the viewpoint position and direction of camera are changed to the right end of the viewpoint movement range r1 in the coordinates system for the three-dimensional surface data S1 of M1).

In step S46, a partial model to be displayed is generated by perspective projection of the image seen from the camera viewpoint position and direction that have been set. The generated partial model is rendered again in the display memory and displayed on the image display portion (display 306). Then, the processing returns to step S38 where user operation is obtained.

At this stage, a mixture ratio of image patterns which have been pasted on top of each other is set in accordance with a camera viewpoint position. For instance in the viewpoint movement range r1 in FIG. 20, the mixture ratio of images g1 and g2 at the left-end position p1 of the range r1 is 1:0, and the mixture ratio of images g1 and g2 at the right-end position p2 of the range r1 is 0:1. At an intermediate position of p1 and p2, the image patterns of images g1 and g2 are pasted on the partial model M1 at the ratio inversely proportional to each of the distances from p1 and p2 respectively.

As set forth above, according to the fourth embodiment, image patterns of two object images, serving as the base of three-dimensional surface data, are mixed, pasted and rendered, and the mixture ratio is altered in accordance with a viewpoint position. Therefore, the image pattern of the surface of object can be made more natural.

Note that although in the third and fourth embodiments, the series of operation from obtaining image data of an object to displaying a three-dimensional image are realized in one processing, they may be performed in two processing: one for three-dimensional data generating processing in steps S31 to S34 and the other for three-dimensional image displaying processing in steps S35 to S46. In such case, to generate three-dimensional data of an object, three-dimensional surface data generated from adjacent images of a plurality of object images and the respective camera movement parameters are temporarily stored in a file as the three-dimensional data of an object. Then, the stored three-dimensional surface data of the object is read out of the file in the processing of generating three-dimensional data of the object in step S35 and the subsequent steps, and an object model is generated.

Further, in each of the above-described embodiments, although three-dimensional surface data of an object is constructed by vertex data and arrays of triangle data, the present invention is not limited to this. For instance, arrays of vertex data may be approximated by Nth-order polynomial, spline surface, super quadrics or spherical harmonics or the like, and these function parameters may be used as three-dimensional data of an object. By this, in a case where three-dimensional data is temporarily stored in a file, three-dimensional data of an object can be stored as parameters of an approximation model. Therefore, a three-dimensional model can be stored with a small memory capacity. Moreover, such approximation model may be reconstructed into three-dimensional surface data including arrays of vertex data and triangle data, at the time of generating a three-dimensional model of an object in step S35. By this, a three-dimensional image of an object can be displayed by the processing similar to each of the above-described embodiments.

In the foregoing third and fourth embodiments, description has been given with an assumption that an object is photographed in front of a solid-color background. If the background does not have a solid color, in a case where an object is photographed from different directions as shown in FIG. 14, it becomes extremely difficult to obtain an accurate parallax in a background region because the image on the background significantly changes. In such case, an outline of the object may be designated by a user prior to the processing in step S32 where a parallax map is extracted. In the parallax map extracting processing, parallax vectors are extracted within an object region designated by the user.

Furthermore, parallax vectors may be extracted for points of the designated outline having large changes (e.g., in a case where a user designates the outline of an object as a polygon, the vertexes of the polygon are extracted). By this, a three-dimensional structure of the object which reflects the user's designation can be generated at the time of generating three-dimensional data of an object.

Further, in each of the foregoing embodiments, description has been provided on a case where an object is photographed at three viewpoints. However it is apparent that the configuration of the present invention can be easily extended to images having arbitrary number of viewpoints larger than three.

Still further, in each of the foregoing embodiments, description has been provided on a case where an object is photographed while the object is one-dimensionally shifted. However, the method of displaying a three-dimensional image as described in the above-described embodiments can also be applied to images having arbitrary viewpoint positions which are three-dimensionally distributed.

Moreover, in the foregoing embodiments, although description has been provided on display processing for displaying a three-dimensional image of an object by one-dimensionally shifting the viewpoint of a camera, an object seen from an arbitrary three-dimensional viewpoint position or directions may be displayed.

As has been described above, according to the third and fourth embodiments, an image of an object can be three-dimensionally displayed based on relatively small amount of the object images. In addition, a three-dimensional image of an object can be displayed with small image distortion without necessitating to generate a highly precise three-dimensional model of an object.

The present invention can be applied to a system constituted by a plurality of devices (e.g., host computer, interface, reader, printer) or to an apparatus comprising a single device (e.g., digital camera).

Further, the object of the present invention can be also achieved by providing a storage medium storing program codes for performing the aforesaid processes to a system or an apparatus, reading the program codes with a computer (e.g., CPU, MPU) of the system or apparatus from the storage medium, then executing the program.

In this case, the program codes read from the storage medium realize the new functions according to the invention, and the storage medium storing the program codes constitutes the invention.

Further, the storage medium, such as a floppy disk, hard disk, an optical disk, a magneto-optical disk, CD-ROM, CD-R, a magnetic tape, a non-volatile type memory card, and ROM can be used for providing the program codes.

Furthermore, besides aforesaid functions according to the above embodiments are realized by executing the program codes which are read by a computer, the present invention includes a case where an OS (Operating System) or the like working on the computer performs a part or entire processes in accordance with designations of the program codes and realizes functions according to the above embodiments.

Furthermore, the present invention also includes a case where, after the program codes read from the storage medium are written in a function expansion card which is inserted into the computer or in a memory provided in a function expansion unit which is connected to the computer, a CPU or the like contained in the function expansion card or unit performs a part or entire process in accordance with designations of the program codes and realizes functions of the above embodiments.

The present invention is not limited to the above embodiments and various changes and modifications can be made within the spirit and scope of the present invention. Therefore, to appraise the public of the scope of the present invention, the following claims are made.

What is claimed is:

1. An image processing apparatus comprising:
obtaining means for obtaining first and second image data representing a first image and a second image, seen from different viewpoints and having a partially overlapped field of view;
first generating means for extracting an object region including a predetermined object image from the first and second images and generating parallax data of the object region;
second generating means for generating an approximation parameter to express the object region in a predetermined approximation model form in a three-dimensional space based on the parallax data; and
forming means for forming a three-dimensional model of the object image based on a camera parameter related to the first and second images and the approximation parameter.

2. The image processing apparatus according to claim 1, wherein said first generating means divides each of the first and second images into a plurality of small regions, obtains parallax distribution data by detecting corresponding small regions between both first and second images, extracts a parallax distribution regarding a small region included in the object region in the first image from the obtained parallax distribution data and generates the parallax data.

3. The image processing apparatus according to claim 1, wherein the object region is a rectangular region including an object image.

4. The image processing apparatus according to claim 1, wherein a predetermined approximation model is a plane model or curve model.

5. The image processing apparatus according to claim 1, wherein the camera parameter includes a distance of lens center and focal distance of a camera at the time of photographing the first and second images, and a length between pixels of image data.

6. The image processing apparatus according to claim 1, further comprising selecting means for selecting an approximation model suitable to the object region based on the parallax data,
wherein said second generating means generates an approximation parameter to express the object region in the approximation model selected by said selecting means.

7. The image processing apparatus according to claim 1, further comprising image generating means for generating a virtual image by arranging the three-dimensional model of an object formed by said forming means in a predetermined three-dimensional coordinates system and projecting the three-dimensional model of the object to a virtual image surface arranged on the three-dimensional coordinates system.

8. The image processing apparatus according to claim 7, wherein projection to the virtual image surface is performed by perspective projection.

9. The image processing apparatus according to claim 7, wherein said forming means forms a three-dimensional model of the object region including the object image, and said image generating means sets a portion besides the object image in the object region transparent when the object region is projected to the virtual image surface.

10. The image processing apparatus according to claim 7, wherein the virtual image surface generated by said image generating means is determined based on a position of a virtual camera arranged at a desired position of the three-dimensional coordinates system and a focal distance given to the virtual camera.

11. The image processing apparatus according to claim 10, further comprising shift operation means for shifting the virtual camera in the three-dimensional space,
wherein said image generating means forms the virtual image surface based on a position of the virtual camera shifted by said shift operation means and projects the object image to the virtual image surface.

12. The image processing apparatus according to claim 7, wherein said image generating means maps, as texture, image data corresponding to the first image, on the object image projected on the virtual image surface.

13. An image processing method comprising:
an obtaining step of obtaining first and second image data representing a first image and a second image, seen from different viewpoints and having a partially overlapped field of view;
a first generating step of extracting an object region including a predetermined object image from the first and second images and generating parallax data of the object region;
a second generating step of generating an approximation parameter to express the object region in a predetermined approximation model form in a three-dimensional space based on the parallax data; and
a forming step of forming a three-dimensional model of the object image based on a camera parameter related to the first and second images and the approximation parameter.

14. The image processing method according to claim 13, wherein said first generating step includes the steps of:
dividing each of the first and second images into a plurality of small regions, and obtaining parallax distribution data by detecting corresponding small regions between both first and second images; and
extracting a parallax distribution regarding a small region included in the object region in the first image from the obtained parallax distribution data and generates the parallax data.

15. The image processing method according to claim 13, wherein the object region is a rectangular region including an object image.

16. The image processing method according to claim 13, wherein a predetermined approximation model is a plane model or curve model.

17. The image processing method according to claim 13, wherein the camera parameter includes a distance of lens center and focal distance of a camera at the time of photographing the first and second images, and a length between pixels of image data.

18. The image processing method according to claim 13, further comprising a selecting step of selecting an approximation model suitable to the object region based on the parallax data,
wherein in said second generating step, an approximation parameter is generated to express the object region in the approximation model selected in said selecting step.

19. The image processing method according to claim 13, further comprising an image generating step of generating a virtual image by arranging the three-dimensional model of an object formed in said forming step in a predetermined three-dimensional coordinates system and projecting the three-dimensional model of the object to a virtual image surface arranged on the three-dimensional coordinates system.

20. The image processing method according to claim 19, wherein projection to the virtual image surface is performed by perspective projection.

21. The image processing method according to claim 19, wherein in said forming step, a three-dimensional model of the object region including the object image is formed, and in said image generating step, a portion besides the object image in the object region is set transparent when the object region is projected to the virtual image surface.

22. The image processing method according to claim 19, wherein the virtual image surface generated in said image generating step is determined based on a position of a virtual camera arranged at a desired position of the three-dimensional coordinates system and a focal distance given to the virtual camera.

23. The image processing method according to claim 22, further comprising a shift operation step of shifting the virtual camera in the three-dimensional space,
wherein in said image generating step, the virtual image surface is formed based on a position of the virtual camera shifted in said shift operation step and the object image is projected to the virtual image surface.

24. The image processing method according to claim 19, wherein in said image generating step, image data corresponding to the first image is mapped as a texture on the object image projected on the virtual image surface.

25. A memory medium storing a control program for causing a computer to perform three-dimensional model generating processing, said control program comprising:
codes for an obtaining step of obtaining first and second image data representing a first image and a second image, seen from different viewpoints and having a partially overlapped field of view;
codes for a first generating step of extracting an object region including a predetermined object image from the first and second images and generating parallax data of the object region;
codes for a second generating step of generating an approximation parameter to express the object region in a predetermined approximation model form in a three-dimensional space based on the parallax data; and
codes for a forming step of forming a three-dimensional model of the object image based on a camera parameter related to the first and second images and the approximation parameter.

26. The memory medium according to claim 25, said control program further comprising codes for an image generating step of generating a virtual image by arranging the three-dimensional model of an object formed in said forming step in a predetermined three-dimensional coordinates system and projecting the three-dimensional model of the object to a virtual image surface arranged on the three-dimensional coordinates system.

27. An image processing apparatus comprising:
first generating means for generating a three-dimensional model of an object for each pair of adjacent object images of a plurality of object images obtained from different viewpoints;
selecting means for selecting a three-dimensional model to be used based on an observation position and the viewpoints of the plurality of object images; and
second generating means for generating a three-dimensional image corresponding to a viewpoint of the observation position by utilizing the three-dimensional model selected by said selecting means.

28. The image processing apparatus according to claim 27, further comprising display control means for displaying the three-dimensional image generated by said second generating means.

29. The image processing apparatus according to claim 27, wherein said second generating means generates a three-dimensional image corresponding to the observation position by perspective projection, utilizing the three-dimensional model selected by said selecting means.

30. The image processing apparatus according to claim 27, further comprising texture mapping means for pasting, on the three-dimensional model, an image pattern of an object image used in generating the three-dimensional model selected by said selecting means.

31. The image processing apparatus according to claim 30, wherein said texture mapping means decides an image pattern to be utilized from the pair of object images used to generate the three-dimensional model which is selected by said selecting means, based on a viewpoint position used in the displaying operation.

32. The image processing apparatus according to claim 30, wherein said texture mapping means pastes, on the three-dimensional model, image patterns of two object images pasted on top of each other, utilized by said selecting means for generating the three-dimensional model.

33. The image processing apparatus according to claim 27, wherein said first generating means generates a three-dimensional model by calculating a three-dimensional position of each portion of the object with the use of the theory of trigonometry based on the pair of object images and respective viewpoint positions.

34. The image processing apparatus according to claim 27, further comprising third generating means for extracting a plurality of shift vectors indicative of shifts of a partial region with respect to a pair of object images, and generating a parameter indicative of shift and direction of a viewpoint between the object images based on the plurality of shift vectors,
wherein said second generating means generates a three-dimensional image corresponding to a viewpoint of the observation position based on the parameter generated by said third generating means and the three-dimensional model selected by said selecting means.

35. An image processing method comprising:
a first generating step of generating a three-dimensional model of an object for each pair of adjacent object images of a plurality of object images obtained from different viewpoints;
a selecting step of selecting a three-dimensional model to be used based on an observation position and the viewpoints of the plurality of object images; and
a second generating step of generating a three-dimensional image corresponding to a viewpoint of the observation position by utilizing the three-dimensional model selected in said selecting step.

36. The image processing method according to claim 35, further comprising a display control step of displaying the three-dimensional image generated in said second generating step.

37. The image processing method according to claim 35, wherein in said second generating step, a three-dimensional image corresponding to the observation position is generated by perspective projection, utilizing the three-dimensional model selected in said selecting step.

38. The image processing method according to claim 35, further comprising a texture mapping step of pasting, on the three-dimensional model, an image pattern of an object image used in generating the three-dimensional model selected in said selecting step.

39. The image processing method according to claim 38, wherein in said texture mapping step, an image pattern to be utilized is decided from the pair of object images used to generate the three-dimensional model which is selected in said selecting step, based on a viewpoint position used in the displaying operation.

40. The image processing method according to claim 38, wherein in said texture mapping step, image patterns of two object images pasted on top of each other, utilized in said selecting step for generating the three-dimensional model, are pasted on the three-dimensional model.

41. The image processing method according to claim 35, wherein in said first generating step, a three-dimensional model is generated by calculating a three-dimensional position of each portion of the object with the use of the theory of trigonometry based on the pair of object images and respective viewpoint positions.

42. The image processing method according to claim 35, further comprising a third generating step of extracting a plurality of shift vectors indicative of shifts of a partial region with respect to a pair of object images, and generating a parameter indicative of shift and direction of a viewpoint between the object images based on the plurality of shift vectors,
wherein in said second generating step, the three-dimensional image corresponding to a viewpoint of the observation position is generated based on the parameter generated in said third generating step and the three-dimensional model selected in said selecting step.

43. A memory medium storing a control program for causing a computer to generate three-dimensional model data, said control program comprising:
codes for a first generating step of generating a three-dimensional model of an object for each pair of adjacent object images of a plurality of object images obtained from different viewpoints;
codes for a selecting step of selecting a three-dimensional model to be used based on an observation position and the viewpoints of the plurality of object images; and
codes for a second generating step of generating a three-dimensional image corresponding to a viewpoint of the observation position by utilizing the three-dimensional model selected in said selecting step.
